(19) United States
(12) Patent Application Publication
(10) Pub. No.: US 2002/0138526 A1
(43) Pub. Date: Sep. 26, 2002

(54) Javascript code optimizer

(75) Inventors: Kevin E. Crawford, Rome, GA (US); Christopher J. Davia, Mableton, GA (US)

Correspondence Address: Richard L. Catania, Esq., Scully, Scott, Murphy & Presser, 400 Garden City Plaza, Garden City, NY, 11530, US

(73) Assignee: INTERNATIONAL BUSINESS MACHINES CORPORATION, ARMONK, NY (US)

(21) Appl. No.: 09/814,042

(22) Filed: Mar. 20, 2001

(51) Int. Cl. G06F 17/21

(52) U.S. Cl. 707/530

(57) ABSTRACT

A method and system for preparing a web content file for downloading over a computer network. The method comprises the steps of receiving a request from a browser for a web content file; in response to receiving the request, reducing the size of the requested file by removing pre-identified subject matter from the file; and downloading to the browser the reduced size file. For example, the reducing step may include the step of removing comments and unused logic blocks from the file. These unused logic blocks are functions that are in the file but not used. The removing step may comprise the steps of consolidating duplicated logic blocks, and shortening recurring identifiers within the file. These duplicated functions may be consolidated by identifying the duplicated functions, and replacing the duplicated functions with a reference to a single function in a library.

### BACKGROUND OF THE INVENTION 1. Field of the Invention

This invention generally relates to computer networks, such as the Internet. More specifically, the invention relates to methods and systems for preparing files for downloading over computer networks.

2. Prior Art

The World-Wide Web (WWW) links many of the servers making up the Internet, each storing documents identified by unique universal resource locators (URLs). Many of the documents stored on Web servers are written in a standard document description language called HTML (hypertext markup language). Using HTML, a designer of Web documents can associate hypertext links or annotations with specific words or phrases in a document (these hypertext links identify the URLs of other Web documents or other parts of the same document providing information related to the words or phrases) and specify visual aspects and the content of a Web page.

A user accesses documents stored on the WWW using a Web browser (a computer program designed to display HTML documents and to communicate with Web servers) running on a Web client connected to the Internet. Typically, this is done by the user selecting a hypertext link (typically displayed by the Web browser as a highlighted word or phrase) within a document being viewed with the Web browser. The Web browser then issues a HTTP (hyertext transfer protocol) request for the requested document to the Web server identified by the requested document=s URL. In response, the designated Web server returns the requested document to the Web browser, also using the HTTP.

The standard HTML syntax of Web pages and the standard communications protocol (HTTP) supported by the WWW guarantee that any Web browser can communicate with any Web server. However, until the invention of the Java programming language and Java applets, there was no way to provide platform-independent application programs over the Internet and the WWW.

Important features of the Java programming language include the architecture-independence of programs written in the Java language, meaning that they can be executed on any computer platform having a Java interpreter, and the verifiabilty of the integrity of such programs, meaning that the integrity of Java programs can be verified prior to their execution.

In the above-discussed operation of the Internet, the Internet browsers are designed to download and display web content files (WCFs). There is a direct relationship between the size of a WCF and the download time of the file. Therefore, in order to keep this time as short as possible, it is important to keep the WCF as small as possible.

### SUMMARY OF THE INVENTION

An object of this invention is to provide an improved method and system for preparing files for downloading over a computer network.

Another object of the present invention is to reduce the amount of time needed to download files over a computer network.

A further object of this invention is to reduce the size of web content files prior to downloading in order to reduce the time needed to download the files.

These and other objects are attained with a method and system for preparing a web content file for downloading over a computer network. The method comprises the steps of receiving a request from a browser for a web content file; in response to receiving the request, reducing the size of the requested file by removing pre-identified subject matter from the file; and downloading to the browser the reduced size file.

For example, the reducing step may include the step of removing comments and unused logic blocks from the file. These unused logic blocks are functions that are in the file but not used.

The removing step may comprise the steps of consolidating duplicated logic blocks, and shortening recurring identifiers within the file. These duplicated functions may be consolidated by identifying the duplicated functions, and replacing the duplicated functions with a reference to a single function in a library.

Further benefits and advantages of the invention will become apparent from a consideration of the following detailed description, given with reference to the accompanying drawings, which specify and show preferred embodiments of the invention.

### BRIEF DESCRIPTION OF THE DRAWINGS

FIG. 1 is a diagrammatic representation of a computer network with which the present invention may be used.

FIG. 2 is a flow chart showing a preferred embodiment of this invention.

FIGS. 3 and 4 diagrammatically illustrate a preferred implementation of the present invention.

### DETAILED DESCRIPTION OF THE PREFERRED EMBODIMENTS

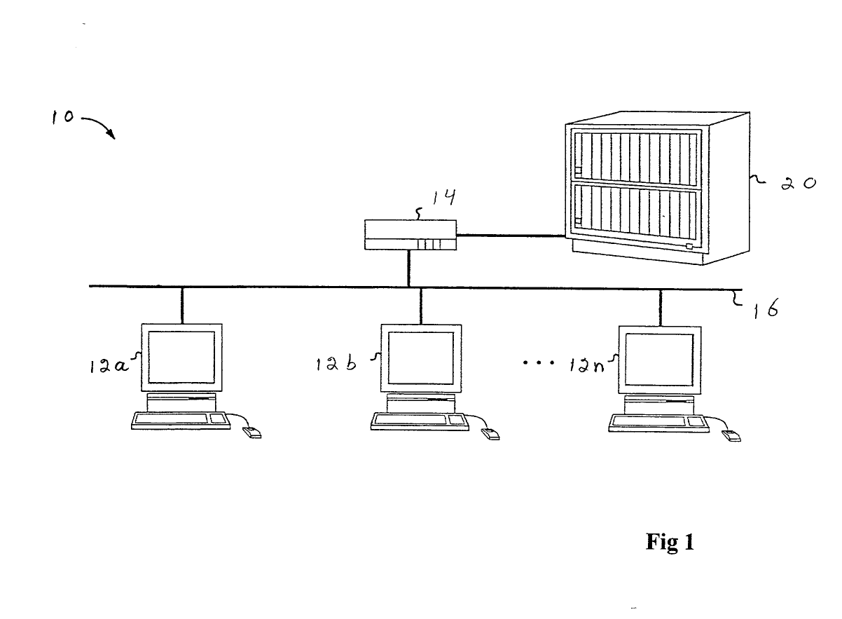

Referring to FIG. 1, network computer system 10 is shown to include, inter alia, computers 12a-12n coupled to server 14 via network or bus 16. Computers 12a-12n may be any one of several well known types of computers such as personal computers or workstations. Server 14 is further coupled to storage system 20 thereby providing a link between individual computers 12a-12n to storage system 20 via server 14. Like many network computer systems, server 14 typically provides the scheduling and routing of data between any of the individual computers 12a-12n and disk storage system 20 as well as between the individual computers 12a-12n themselves. Although not shown, storage system 20 may also be connected to several servers similar to server 14 and thereby service other network computer systems. Additionally, storage system 20 may be coupled directly to one or more individual computer systems such as mainframe computer systems rather than being connected to several computers through a server such as server 14. Also, network 16 may be any network of devices and connections which provides a data communications system. Network 16 may be the World Wide Web, although the present invention may be used with other networks.

According to a preferred embodiment of the present invention, each of the computer systems 12a-12n is capable of running any one of the well known web clients (i.e. browsers or similar such applications). As is generally known, the web clients allow for computers coupled to the same network to communicate using the hyper text transfer protocol (HTTP) information and communication system. As is also known, web clients are typically useful for accessing information stored on various computers distributed about and connected to a network.

Web clients or browsers are application programs that run on a local computer and operate by displaying, in a graphical format, information obtained from servers via HTTP. The fields obtained from the servers may contain information in any one of several well known formats such as HTML, Java, JavaScript, etc. The display is present based on reading and interpreting the accessed information and displaying the results in a window of the web client application.

In the operation of the network computer system 10, the Internet browsers download and display web content files (WCFs). There is a direct relationship between the size of a WCF and the download time of the file. Consequently, in order to keep this download time as short as possible, it is important to keep the WCF as small as possible.

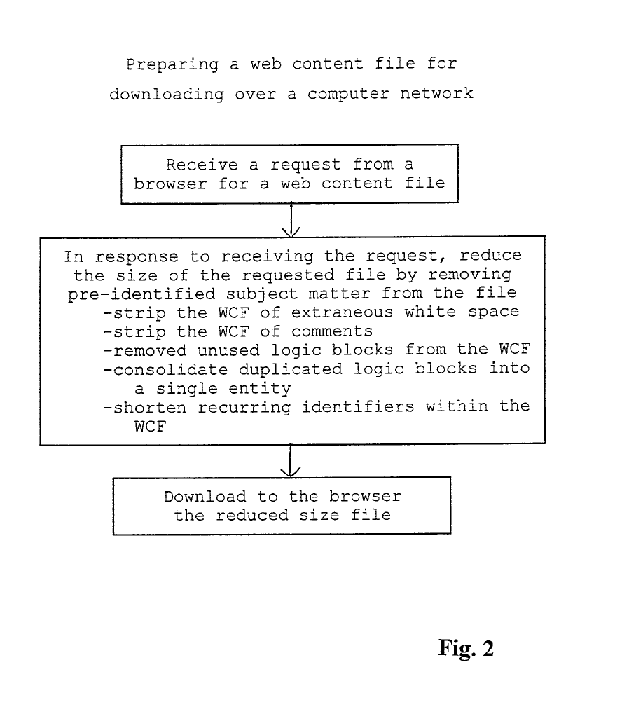

The present invention addresses this problem by analyzing and modifying web content files. With reference to FIG. 2, in accordance with the present invention, after a request is received from a browser for a web content file, the size of the requested file is reduced by removing pre-identified subject matter from the file, and the reduced size file is downloaded to the browser.

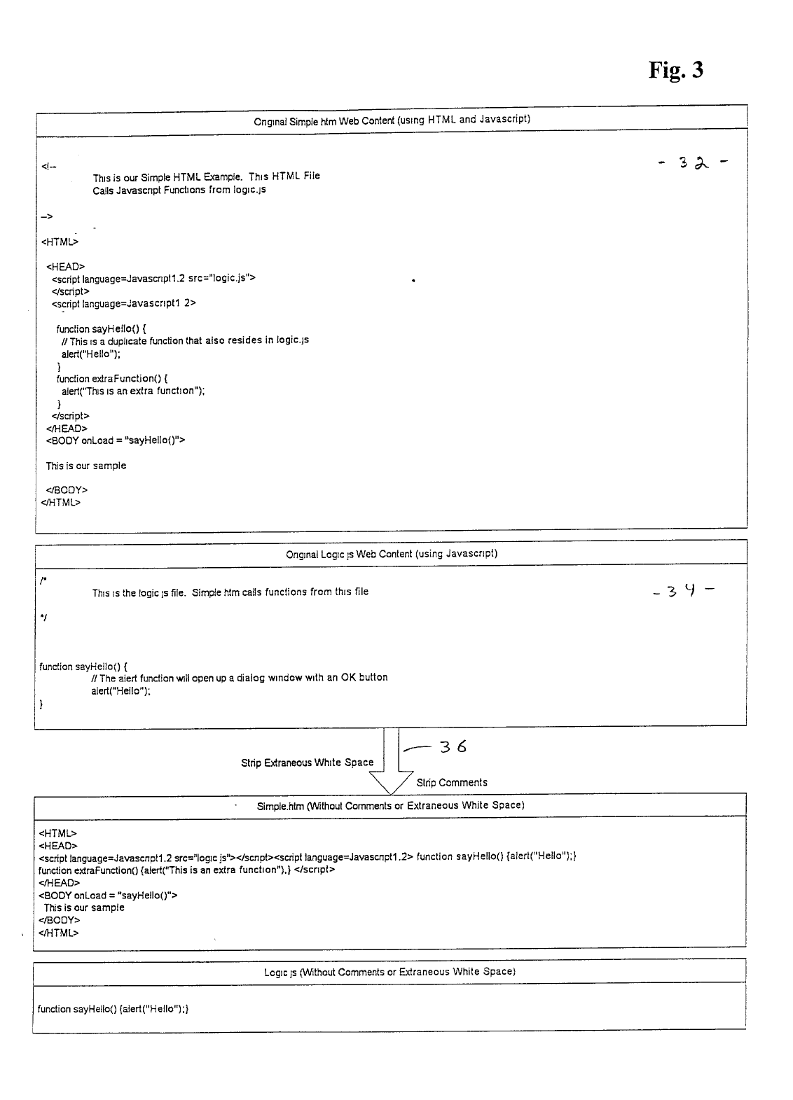

FIG. 3 illustrates a Web Content file 32 (using HTML and Javascript) and a logic Web Content file 34 (using Javascript). With the preferred embodiment of this invention, for example, the size of the requested file may be reduced by stripping the WCFs of extraneous white space, as represented at 36. For example, this may be spaces, Line Feeds, Carriage Returns, and Tabs. Also as represented at 36, the invention also strips the WCFs of comments. For example, if the WCF contains Javascript, the following can be removed:

/* aComment */

// a commented Line.

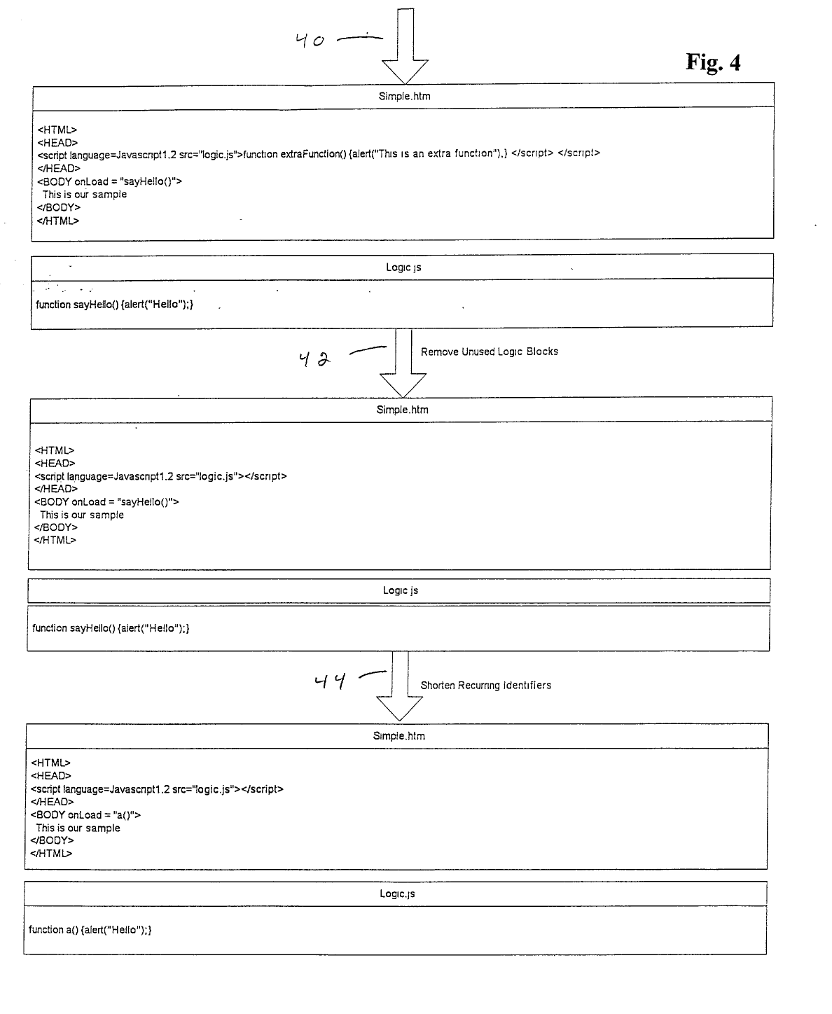

As represented at 40, 42 and 44 in FIG. 4, the preferred embodiment of the invention also consolidates duplicated logic blocks into a single entity, removes unused logic blocks from the WCF, and shortens recurring identifiers. Unused logic blocks may be, for example, Javascript functions that are in the WCF, but not used. Logic blocks, such as Javascript functions, that are duplicated within one or multiple WCFs can be optimized to reference a single function in a library. Additionally, the invention preferably shortens recurring identifiers within the WCF. For example, a Javascript variable: aUser can be optimized to be one character: a. As another example, the Javascript function: do Something( ) can be optimized to d( ).

While it is apparent that the invention herein disclosed is well calculated to fulfill the objects stated above, it will be appreciated that numerous modifications and embodiments may be devised by those skilled in the art, and it is intended that the appended claims cover all such modifications and embodiments as fall within the true spirit and scope of the present invention.

1. A method of preparing a web content file for downloading over a computer network, comprising the steps:
receiving a request from a browser for a web content file;
in response to receiving the request, reducing the size of the requested file by removing pre-identified subject matter from the file; and
downloading to the browser the reduced size file.

2. A method according to claim 1, wherein the reducing step includes the step of removing comments and unused logic blocks from the file.

3. A method according to claim 2, wherein the unused logic blocks are functions that are in the file but not used.

4. A method according to claim 1, wherein the reducing step includes the step of consolidating duplicated logic blocks, and shortening recurring identifiers within the file.

5. A method according to claim 4, wherein the consolidating step includes the step of identifying duplicated functions and replacing the duplicated functions with a reference to a single function in a library.

6. A system for preparing a web content file for downloading over a computer network, comprising:
means for receiving a request from a browser for a web content file;
means for reducing the size of the requested file, in response to receiving the request, by removing pre-identified subject matter from the file; and
means for downloading to the browser the reduced size file.

7. A system according to claim 6, wherein the reducing means includes means for removing comments and unused logic blocks from the file.

8. A system according to claim 7, wherein the unused logic blocks are functions that are in the file but not used.

9. A system according to claim 6, wherein the reducing means includes the means for consolidating duplicated logic blocks, and means for shortening recurring identifiers within the file.

10. A system according to claim 9, wherein the consolidating means includes means for identifying duplicated functions and replacing the duplicated functions with a reference to a single function in a library.

11. A program storage device readable by machine and tangibly embodying a set of instructions for the machine to perform method steps for preparing a web content file for downloading over a computer network, said method steps comprising:
receiving a request from a browser for a web content file;
in response to receiving the request, reducing the size of the requested file by removing pre-identified subject matter from the file; and
downloading to the browser the reduced size file.

12. A program storage device according to claim 11, wherein the reducing step includes the step of removing comments and unused logic blocks from the file.

13. A program storage device according to claim 12, wherein the unused logic blocks are functions that are in the file but not used.

14. A program storage device according to claim 11, wherein the reducing step includes the step of consolidating duplicated logic blocks, and shortening recurring identifers within the file.

15. A program storage device according to claim 14, wherein the consolidating step includes the step of identifying duplicated functions and replacing the duplicated functions with a reference to a single function in a library.
